(19) United States
(12) Patent Application Publication
(10) Pub. No.: US 2022/0166528 A1
(43) Pub. Date: May 26, 2022

(54) WIRELESS COMMUNICATION MONITORING SYSTEM, WIRELESS COMMUNICATION ABNORMALITY INFORMATION PRESENTING METHOD, AND NON-TRANSITORY COMPUTER READABLE MEDIUM

(71) Applicant: NEC Corporation, Minato-ku, Tokyo (JP)

(72) Inventor: Hiroaki NAGANO, Tokyo (JP)

(73) Assignee: NEC Corporation, Minato-ku, Tokyo (JP)

(21) Appl. No.: 17/442,786

(22) PCT Filed: Jan. 21, 2020
(86) PCT No.: PCT/JP2020/001806

§ 371 Date: Sep. 24, 2021

(30) Foreign Application Priority Data
Mar. 28, 2019 (JP) 2019-063149

(51) Int. Cl. H04B 17/373; H04B 17/391; H04W 24/10

(52) U.S. Cl. CPC H04B 17/373; H04W 24/10; H04B 17/391

(57) ABSTRACT

A wireless communication monitoring system for monitoring an abnormality of a radio wave state in wireless communication includes a processor configured to: hold, as prediction information, information related to a fluctuation in the radio wave state that is able to be predicted and a fluctuation in the radio wave state being permitted; detect an occurrence of a fluctuation in the radio wave state; set the occurrence as fluctuation information; and output detailed information related to a fluctuation in the radio wave state when the fluctuation information detected does not coincide with the prediction information held.

### TECHNICAL FIELD

The present disclosure relates to a wireless communication monitoring system, a wireless communication abnormality information presenting method, and a wireless communication abnormality information presenting program. The present disclosure particularly relates to a wireless communication monitoring system, a wireless communication abnormality information presenting method, and a wireless communication abnormality information presenting program, being able to notify a supervisor and the like of an unexpected fluctuation in a radio wave state in wireless communication, and improve operating efficiency and the like of the supervisor and the like.

### BACKGROUND ART

As described in “Radio Communication System and Radio Communication Method” in Japanese Unexamined Patent Application Publication No. 2011-9974 in Patent Literature 1, and the like, a basic technique related to visualization of a communication state and the like has been almost established in a wireless communication field such as a wireless local area network (LAN). However, it is still difficult to say that a user interface (UI) and a user experience (UX) technique for efficiently using the basic technique are sufficient.

In other words, a current technique is in a condition as described in “Consulting on Problem in Radio Communication” of an NEC-Web page in Non Patent Literature 1, for example, and a burden on a supervisor and the like who manage wireless communication increases. This condition is a condition that a technique for detecting presence of an interference source and the like has been put to practical use by analyzing, by a radio wave measurement, information related to an external radio wave generation source and an obstacle affecting wireless communication, but data collected as a monitoring result are enormous and only a specialist can understand displayed data among anyone who views the displayed data.

### CITATION LIST

### Patent Literature

[Patent Literature 1] Japanese Unexamined Patent Application Publication No. 2011-9974

### Non Patent Literature

[Non Patent Literature 1] NEC, “Consulting on Problem in Radio Communication”, [online], IoT of NEC, [search on Feb. 6, 2019], Internet (URL: “https://jpn.nec.com/iot/platform/consulting-wireless/index.html”)

### SUMMARY OF INVENTION

### Technical Problem

As described above, the current technique described above is in a still insufficient condition in a point that a function of monitoring wireless communication is efficiently used.

For example, by using the technique described in Non Patent Literature 1 described above, a fluctuation in a radio wave state in the entire wireless communication can be observed. However, in this technique, an observation result remains as display for a specialist. Furthermore, in this technique, for example, a predictable fluctuation in a radio wave state and a permitted fluctuation that do not affect business-related communication are also detected and recorded as an observation result, and thus an amount of data recorded for an analysis is also enormous.

In general, what is important as a function of monitoring wireless communication is to detect a situation where a radio wave state fluctuates due to unexpected entry of a radio wave interference source and the like. However, the current technique such as Non Patent Literature 1 described above requires a specialist such as a supervisor to perform an operation of visually finding an unexpected fluctuation (i.e., an unexpected abnormality of a wireless radio wave) in a radio wave state from all fluctuations in the radio wave state that result in an enormous amount of data, and the like.

An object of the present disclosure has been made in view of such a situation, and is to provide a wireless communication monitoring system, a wireless communication abnormality information presenting method, and a wireless communication abnormality information presenting program, being able to detect an unexpected fluctuation in a radio wave state in wireless communication and notifying a supervisor and the like of the fluctuation.

### Solution to Problem

In order to solve the problem described above, a wireless communication monitoring system, a wireless communication abnormality information presenting method, and a wireless communication abnormality information presenting program according to the present disclosure mainly adopt a following characteristic configuration.

(1) A wireless communication monitoring system according to the present disclosure includes:

monitoring a radio wave state in wireless communication;

a holding means for holding, as prediction information, information related to a fluctuation in the radio wave state that is able to be predicted and a fluctuation in the radio wave state being permitted;

a detection means for detecting an occurrence of a fluctuation in the radio wave state, and setting the occurrence as fluctuation information; and

an output means for outputting detailed information related to a fluctuation in the radio wave state when the fluctuation information detected by the detection means does not coincide with the prediction information held in the holding means.

(2) A wireless communication abnormality information presenting method according to the present disclosure includes:

presenting detection of an occurrence of a radio wave state in wireless communication;

a holding step of holding, as prediction information, information related to a fluctuation in the radio wave state that is able to be predicted and a fluctuation in the radio wave state being permitted;

a detection step of detecting an occurrence of a fluctuation in the radio wave state, and setting the occurrence as fluctuation information; and

an output step of outputting detailed information related to a fluctuation in the radio wave state when the information related to a fluctuation in the radio wave state detected in the detection step does not coincide with the prediction information held in the holding step.

(3) A wireless communication abnormality information presenting program according to the present disclosure causes a computer to execute:

processing of presenting detection of an occurrence of a radio wave state in wireless communication, and

includes:

a holding function of holding, as prediction information, information related to a fluctuation in the radio wave state that is able to be predicted and a fluctuation in the radio wave state being permitted;

a detection function of detecting an occurrence of a fluctuation in the radio wave state, and setting the occurrence as fluctuation information; and

an output function of outputting detailed information related to a fluctuation in the radio wave state when the information related to a fluctuation in the radio wave state detected in the detection function does not coincide with the prediction information held in the holding function.

### Advantageous Effects of Invention

A wireless communication monitoring system, a wireless communication abnormality information presenting method, and a wireless communication abnormality information presenting program according to the present disclosure are able to mainly achieve an effect as described below.

In other words, a supervisor and the like can concentrate on an analysis of a wireless communication abnormal state that requires actual treatment and consideration of a means for handling the wireless communication abnormal state, and operating efficiency and the like of the supervisor and the like can be improved. The reason is that, the present disclosure presents, as an abnormal state, only detailed information related to an unexpected fluctuation in a radio wave state to a supervisor and the like, and includes a filtering function of excluding a state fluctuation that may be predicted and a permitted state fluctuation.

### BRIEF DESCRIPTION OF THE DRAWINGS

FIG. 1 is a system configuration diagram illustrating one configuration example of a wireless communication monitoring system according to an example embodiment.

FIG. 2 is a block configuration diagram illustrating one example of an internal configuration of an unexpected radio wave state fluctuation-detection means in the wireless communication monitoring system illustrated in FIG. 1.

### DESCRIPTION OF EXAMPLE EMBODIMENTS

A suitable example embodiment of a wireless communication monitoring system, a wireless communication abnormality information presenting method, and a wireless communication abnormality information presenting program according to the present disclosure will be described below with reference to accompanying diagrams. Note that, in the following description, the wireless communication monitoring system and the wireless communication abnormality information presenting method according to the present disclosure will be described, but it is needless to say that the wireless communication abnormality information presenting method may be performed as the wireless communication abnormality information presenting program that can be executed by a computer, or the wireless communication abnormality information presenting program may be recorded in a computer-readable recording medium. Further, a drawing reference sign provided to each following drawing is provided to each component as one example to facilitate understanding for the sake of convenience, and it is needless to say that the sign is not intended for limiting the present disclosure to an illustrated aspect.

### Characteristic of Present Example Embodiment

Prior to description of the present example embodiment, an outline of a characteristic of the present example embodiment will be described first. When a current technique adopted in a visualization service and the like in a wireless communication condition is used, a dynamic change such as an approach of an interference radio wave source can also be captured in addition to static estimation of a propagation state of a radio wave. For example, in the current technique as described in Non Patent Literature 1 described above, presence of an interference source can be detected by using a technique for measuring a propagation state of a radio wave and estimating a radio wave condition and the like in a building, and information about a position of the interference source and the like, a condition of interference, and the like can be collected.

However, when all fluctuations in a radio wave state are presented to a supervisor and the like, an amount of information becomes enormous since a predictable change and a permitted change that do not affect actual communication are also detected. As a result, an expert technique is also required for classifying information being a monitoring result, it is difficult to accurately extract an occurrence of an unpredictable abnormal radio wave state that actually requires treatment, and a current technique is in an insufficient condition for a purpose of monitoring an abnormality and the like.

Thus, in wireless communication, the present example embodiment can substantially ignore and exclude, from an observation target, a change in facility installation, a movement of staff, entry of a radio wave source that may be predicted, and the like, and can set, as main characteristics, extracting only an occurrence of an unexpected fluctuation in a radio wave state that requires actual treatment, collecting detailed information related to the unexpected fluctuation in the radio wave state, and notifying a supervisor and the like of the collected information.

In other words, the present example embodiment sets, as main characteristics, comparing an actually detected fluctuation in a radio wave state with a fluctuation that may be predicted and a permitted fluctuation for an occurrence of the detected fluctuation, extracting, as an unexpected (unplanned) fluctuation in the radio wave state that needs to be handled, a fluctuation in the radio wave state that does not coincide with the fluctuation that may be predicted and the permitted fluctuation, acquiring/storing detailed information related to the extracted fluctuation, and presenting the detailed information to a supervisor and the like. Thus, handling of an unpredicted wireless communication abnormality by a supervisor and the like can increase in efficiency.

### Configuration Example of Present Example Embodiment

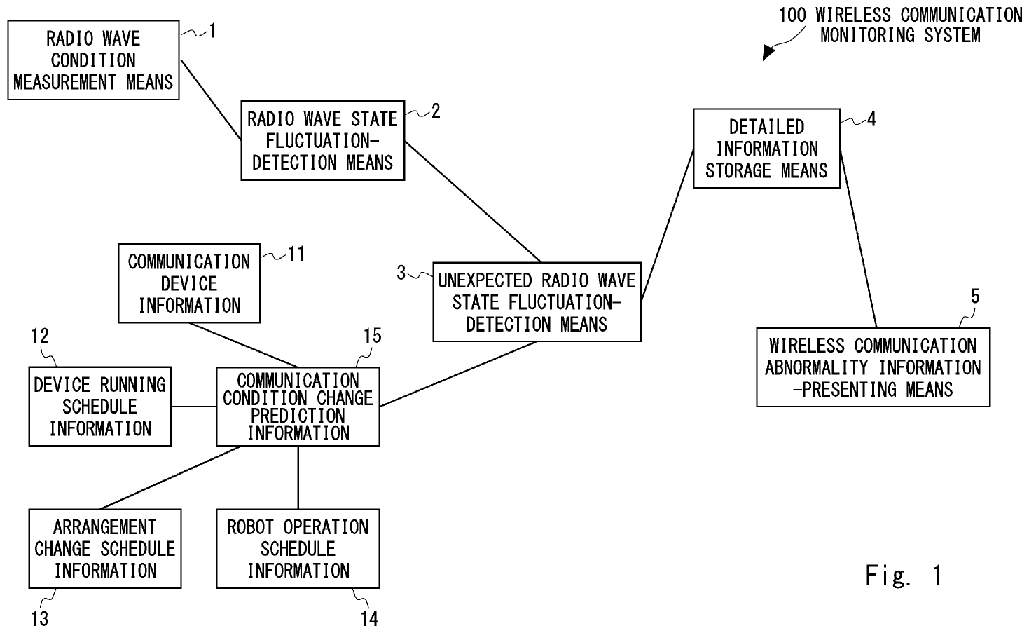

Next, a configuration example of an example embodiment of a wireless communication monitoring system according to the present example embodiment will be described with reference to FIG. 1. FIG. 1 is a system configuration diagram illustrating one configuration example of the wireless communication monitoring system according to the present example embodiment.

A wireless communication monitoring system 100 illustrated in FIG. 1 as the present example embodiment can include a radio wave condition measurement means 1, a radio wave state fluctuation-detection means 2, an unexpected radio wave state fluctuation-detection means 3, a detailed information storage means 4, and a wireless communication abnormality information-presenting means 5. The wireless communication monitoring system 100 can be configured in such a way as to use each piece of information of communication device information 11, device running schedule information 12, arrangement change schedule information 13, robot operation schedule information 14, and communication condition change prediction information 15.

In the wireless communication monitoring system 100, information related to a fluctuation in a radio wave state that may be predicted or is permitted is acquired from the communication device information 11 indicating an attribute of a communication device for identifying a communication device permitted to be at least brought in, the device running schedule information 12 indicating a running schedule of the communication device, the arrangement change schedule information 13 indicating a schedule of an arrangement change in the communication device, the robot operation schedule information 14 indicating an operation schedule of a robot that emits a wireless radio wave in a wireless communication frequency band, and the like, and the acquired information is held in advance as the communication condition change prediction information 15 by a holding means. In other words, the wireless communication monitoring system 100 includes the holding means for holding in advance the communication condition change prediction information 15 as information related to a fluctuation in a radio wave state that may be predicted and a fluctuation in the radio wave state being permitted.

Further, a communication condition (radio wave condition) is not only changed by a communication device having attribute information included in the communication device information 11, but is also changed by a change in a movement or the like of an obstacle that does not become a radio wave source, and the like, and a movement or the like of such an obstacle can be recognized in advance. Thus, the device running schedule information 12 is not limited to information indicating a running schedule of the communication device, but can be information indicating a running schedule of a device such as a machine tool in a factory without the communication device being equipped, or information also including such information. Further, the arrangement change schedule information 13 is not limited to information indicating a schedule of an arrangement change in the communication device, but can be information related to an arrangement change in an obstacle such as a partition in a building, or information also including such information. Further, even a robot that does not emit a wireless radio wave in a wireless communication frequency band becomes an obstacle, and thus a communication condition is changed by a movement of the robot. Thus, the robot operation schedule information 14 can be information indicating an operation schedule of such a robot that does not emit a wireless radio wave, or information also including such information. In this way, the communication condition change prediction information 15 can include at least one of the various pieces of information described above.

The radio wave condition measurement means 1 detects an occurrence of an interference source (i.e., an occurrence of a change in a radio wave state), based on a result of continuously observing wireless communication, and identifies a position of the detected interference source and a frequency band having a possibility of interference. Further, the radio wave state fluctuation-detection means 2 is a detection means for continuing to monitor a position of the interference source detected in the radio wave condition measurement means 1, confirming a continuous occurrence, and thus detecting a fluctuation in the radio wave state.

Further, the unexpected radio wave state fluctuation-detection means 3 compares information indicating the fluctuation in the radio wave state detected by the radio wave state fluctuation-detection means 2 with the communication condition change prediction information 15 being held in advance. As a result of the comparison, when the information does not coincide with the communication condition change prediction information 15, the unexpected radio wave state fluctuation-detection means 3 determines that the radio wave state fluctuation information detected by the radio wave state fluctuation-detection means 2 is an unexpected radio wave state fluctuation, collects detailed information related to the unexpected radio wave state fluctuation, and transmits the detailed information to the detailed information storage means 4. The unexpected radio wave state fluctuation-detection means 3 is one example of an output means for outputting detailed information related to a fluctuation in a radio wave state when fluctuation information detected by the detection means does not coincide with prediction information held in the holding means. In this example, the output means, i.e., the unexpected radio wave state fluctuation-detection means 3 is configured to further include a comparison means for comparing the fluctuation information about the radio wave state detected by the detection means, i.e., the radio wave condition measurement means 1 with the prediction information being held by the holding means, i.e., the communication condition change prediction information 15.

Further, the detailed information storage means 4 stores the detailed information related to the unexpected radio wave state fluctuation being transmitted from the unexpected radio wave state fluctuation-detection means 3. Further, the wireless communication abnormality information-presenting means 5 presents, as wireless communication abnormality information to a supervisor and the like, the detailed information related to the unexpected radio wave state fluctuation being stored by the detailed information storage means 4.

### Description of Operation in Present Example Embodiment

Next, one example of an operation of the wireless communication monitoring system 100 illustrated in FIG. 1 as the present example embodiment will be described in detail.

When the radio wave condition measurement means 1 detects an occurrence of a change in a radio wave state due to radio wave interference and the like in wireless communication, the radio wave condition measurement means 1 identifies a position (for example, a position of an interference source) where the detected change in the radio wave state occurs and a frequency band having a possibility of the change (interference), and notifies the radio wave state fluctuation-detection means 2 of the position and the frequency band. When the radio wave state fluctuation-detection means 2 receives, from the radio wave condition measurement means 1, the notification about the position (for example, the position of the interference source) where the change in the radio wave state occurs and the frequency band having a possibility of the change (interference), the radio wave state fluctuation-detection means 2 continues to monitor the position (i.e., the position of the interference source) where the change in the radio wave state occurs, and checks whether the change in the radio wave state continues to occur for a predetermined period of time. This check is a check of whether a fluctuation in the radio wave state occurs. Then, when the radio wave state fluctuation-detection means 2 detects an occurrence of a fluctuation in the radio wave state, the radio wave state fluctuation-detection means 2 notifies the unexpected radio wave state fluctuation-detection means 3 of the occurrence as radio wave state fluctuation occurrence information. Note that, the radio wave state fluctuation-detection means 2 may not immediately notify the unexpected radio wave state fluctuation-detection means 3 of the radio wave state fluctuation occurrence information in real time, and may store the radio wave state fluctuation occurrence information for a predetermined fixed period and notify the unexpected radio wave state fluctuation-detection means 3 of the radio wave state fluctuation occurrence information at a point in time when the fixed period has elapsed.

The unexpected radio wave state fluctuation-detection means 3 compares the fluctuation in the radio wave state being notified from the radio wave state fluctuation-detection means 2 with the communication condition change prediction information 15 being held in advance as a fluctuation that may be predicted and a fluctuation being permitted, and determines whether the notified fluctuation in the radio wave state is an unexpected fluctuation in the radio wave state that does not coincide with the communication condition change prediction information 15.

Then, as a determination result, when the unexpected radio wave state fluctuation-detection means 3 determines that the fluctuation is an unexpected fluctuation in the radio wave state, the unexpected radio wave state fluctuation-detection means 3 collects detailed information related to the unexpected fluctuation in the radio wave state, and transmits the detailed information to the detailed information storage means 4. The detailed information storage means 4 stores the detailed information transmitted from the unexpected radio wave state fluctuation-detection means 3.

Thereafter, the wireless communication abnormality information-presenting means 5 presents, to a supervisor and the like, the detailed information stored in the detailed information storage means 4. Note that, the detailed information is information including at least a position (for example, a position of an interference source) where a change in a radio wave state being identified in the radio wave condition measurement means 1 occurs and a frequency band having a possibility of the change (interference), i.e., information including at least information related to a position where a fluctuation in a radio wave state indicating continuation of a change for a predetermined period of time occurs and a frequency band having a possibility of the fluctuation.

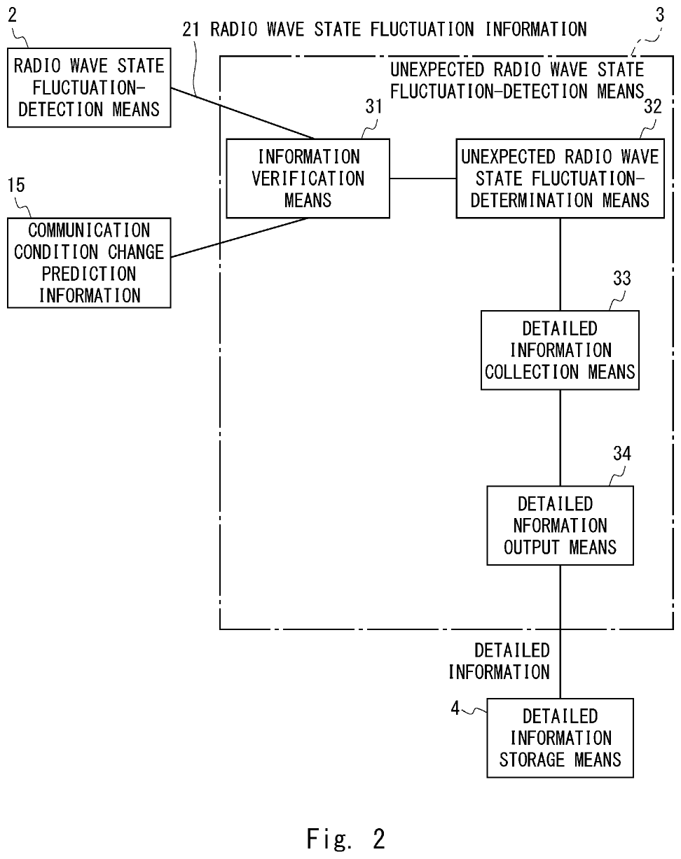

Herein, one example of an internal configuration of the unexpected radio wave state fluctuation-detection means 3 will be described by using FIG. 2. FIG. 2 is a block configuration diagram illustrating one example of the internal configuration of the unexpected radio wave state fluctuation-detection means 3 in the wireless communication monitoring system 100 illustrated in FIG. 1.

As illustrated in FIG. 2, the unexpected radio wave state fluctuation-detection means 3 is configured to include an information verification means 31, an unexpected radio wave state fluctuation-determination means 32, a detailed information collection means 33, and a detailed information output means 34. Herein, the information verification means 31 is a comparison means for comparing information indicating a fluctuation in a radio wave state being notified as radio wave state fluctuation information 21 from the radio wave state fluctuation-detection means 2 with the communication condition change prediction information 15 being held in advance as a fluctuation that may be predicted and a fluctuation being permitted.

Further, as a verification result in the information verification means 31, when the radio wave state fluctuation information 21 from the radio wave state fluctuation-detection means 2 does not coincide with the communication condition change prediction information 15, the unexpected radio wave state fluctuation-determination means 32 determines that an unexpected fluctuation in the radio wave state occurs. Further, the detailed information collection means 33 collects detailed information related to the unexpected fluctuation in the radio wave state. Further, the detailed information output means 34 transmits, to the detailed information storage means 4, the detailed information related to the unexpected fluctuation in the radio wave state being collected in the detailed information collection means 33.

By performing the operation as described above, a supervisor and the like can exclude a state fluctuation that may be predicted and a state fluctuation being permitted, refer to only detailed information related to an unexpected fluctuation in a radio wave state, and thus concentrate on an analysis of a wireless communication abnormal state that requires actual treatment and consideration of a means for handling the wireless communication abnormal state.

### Description of Effect in Present Example Embodiment

As described above in detail, in the present example embodiment, only detailed information related to an unexpected fluctuation in a radio wave state is presented to a supervisor and the like, and thus operating efficiency and the like of the supervisor and the like can be improved. The reason is that the wireless communication monitoring system 100 illustrated in FIGS. 1 and 2 includes, as a component, a filtering function of excluding a fluctuation in a radio wave state that may be predicted and a fluctuation in a radio wave state being permitted.

### Other Example Embodiment

As described in the example embodiment described above, the wireless communication monitoring system according to the present disclosure has a characteristic that the wireless communication monitoring system substantially includes a filtering function of excluding a fluctuation in a radio wave state that may be predicted and a fluctuation in a radio wave state that may be permitted, and can also be applied to a wireless communication monitoring system for collecting information related to all fluctuations in a radio wave state by using a current technique. In other words, the wireless communication monitoring system according to the present disclosure does not prevent simultaneous use with a current system for collecting all pieces of fluctuation information about a radio wave state.

Although the wireless communication monitoring system as a configuration of hardware and a method of the wireless communication monitoring system have been described above in each of the example embodiments described above, the present disclosure is not limited to the example embodiments. A content of the present disclosure can also achieve any processing by causing a processor such as a central processing unit (CPU) to execute a computer program.

Further, the program described above is stored by using a non-transitory computer-readable medium of various types, and can be supplied to a computer. The non-transitory computer-readable medium includes a tangible storage medium of various types. Examples of the non-transitory computer-readable medium include a magnetic recording medium (for example, a flexible disk, a magnetic tape, and a hard disk drive), a magneto-optical recording medium (for example, a magneto-optical disk), a CD-read only memory (CD-ROM) a CD-R, a CD-R/W, and a semiconductor memory (for example, a mask ROM, a programmable ROM (PROM), an erasable PROM (EPROM), a flash ROM, and a random access memory (RAM)). Further, the program may be supplied to the computer by a transitory computer-readable medium of various types. Examples of the transitory computer-readable medium include an electric signal, an optical signal, and an electromagnetic wave. The transitory computer-readable medium can supply the program to the computer via a wired communication path such as an electric wire and an optical fiber, or a wireless communication path.

### (Supplementary Note)

A part or the whole of the example embodiments described above can be described as, but not limited to, the following supplementary notes.

### (Supplementary Note 1)

A wireless communication monitoring system comprising:

monitoring a radio wave state in wireless communication;

holding means for holding, as prediction information, information related to a fluctuation in the radio wave state that is able to be predicted and a fluctuation in the radio wave state being permitted;

detection means for detecting an occurrence of a fluctuation in the radio wave state, and setting the occurrence as fluctuation information; and

output means for outputting detailed information related to a fluctuation in the radio wave state when the fluctuation information detected by the detection means does not coincide with the prediction information held in the holding means.

### (Supplementary Note 2)

The wireless communication monitoring system according to Supplementary Note 1, further comprising comparison means for comparing the fluctuation information detected by the detection means with the prediction information held by the holding means.

### (Supplementary Note 3)

The wireless communication monitoring system according to Supplementary Note 1 or 2, wherein the prediction information includes at least one of attribute information related to a communication device, information indicating a running schedule of the communication device, information indicating an arrangement change schedule of the communication device, information indicating an operation schedule of a robot that emits a wireless radio wave in a wireless communication frequency band, information indicating a running schedule of a device other than the communication device, information indicating an arrangement change schedule of an obstacle, and information indicating an operation schedule of a robot that does not emit the wireless radio wave.

### (Supplementary Note 4)

The wireless communication monitoring system according to any one of Supplementary Notes 1 to 3, wherein the detailed information related to a fluctuation in the radio wave state includes information related to a position where a fluctuation in a radio wave state in wireless communication occurs and a frequency having a possibility of the fluctuation.

### (Supplementary Note 5)

A wireless communication abnormality information presenting method comprising:

presenting detection of an occurrence of a radio wave state in wireless communication;

a holding step of holding, as prediction information, information related to a fluctuation in the radio wave state that is able to be predicted and a fluctuation in the radio wave state being permitted;

a detection step of detecting an occurrence of a fluctuation in the radio wave state, and setting the occurrence as fluctuation information; and

an output step of outputting detailed information related to a fluctuation in the radio wave state when the information related to a fluctuation in the radio wave state detected in the detection step does not coincide with the prediction information held in the holding step.

### (Supplementary Note 6)

The wireless communication abnormality information presenting method according to Supplementary Note 5, further comprising a comparison step of comparing the fluctuation information detected in the detection step with the prediction information held in the holding step.

### (Supplementary Note 7)

The wireless communication abnormality information presenting method according to Supplementary Note 5 or 6, wherein the prediction information includes at least one of attribute information related to a communication device, information indicating a running schedule of the communication device, information indicating an arrangement change schedule of the communication device, information indicating an operation schedule of a robot that emits a wireless radio wave in a wireless communication frequency band, information indicating a running schedule of a device other than the communication device, information indicating an arrangement change schedule of an obstacle, and information indicating an operation schedule of a robot that does not emit the wireless radio wave.

### (Supplementary Note 8)

The wireless communication abnormality information presenting method according to any one of Supplementary Notes 5 to 7, wherein the detailed information related to a fluctuation in the radio wave state includes information related to a position where a fluctuation in a radio wave state in wireless communication occurs and a frequency having a possibility of the fluctuation.

### (Supplementary Note 9)

A wireless communication abnormality information presenting program causing a computer to execute

processing of presenting detection of an occurrence of a radio wave state in wireless communication, and the computer includes:

a holding step of holding, as prediction information, information related to a fluctuation in the radio wave state that is able to be predicted and a fluctuation in the radio wave state being permitted;

a detection step of detecting an occurrence of a fluctuation in the radio wave state, and setting the occurrence as fluctuation information; and

an output step of outputting detailed information related to a fluctuation in the radio wave state when the information related to a fluctuation in the radio wave state detected in the detection step does not coincide with the prediction information held in the holding step.

### (Supplementary Note 10)

The wireless communication abnormality information presenting program according to Supplementary Note 9, further includes a program causing the computer to execute a comparison step of comparing the fluctuation information detected in the detection step with the prediction information held in the holding step.

### (Supplementary Note 11)

The wireless communication abnormality information presenting program according to Supplementary Note 9 or 10, wherein the prediction information includes at least one of attribute information related to a communication device, information indicating a running schedule of the communication device, information indicating an arrangement change schedule of the communication device, information indicating an operation schedule of a robot that emits a wireless radio wave in a wireless communication frequency band, information indicating a running schedule of a device other than the communication device, information indicating an arrangement change schedule of an obstacle, and information indicating an operation schedule of a robot that does not emit the wireless radio wave.

### (Supplementary Note 12)

The wireless communication abnormality information presenting program according to any one of Supplementary Notes 9 to 11, wherein the detailed information related to a fluctuation in the radio wave state includes information related to a position where a fluctuation in a radio wave state in wireless communication occurs and a frequency having a possibility of the fluctuation.

The configuration of the suitable example embodiment has been described above. However, it should be noted that the example embodiment is merely exemplification of the invention of the present application and does not limit the invention of the present application at all. A person skilled in the art can easily understand that various modifications and changes can be made according to a specific application without departing from the scope of the invention of the present application. In other words, although the invention of the present application has been described with reference to the example embodiments, the invention of the present application is not limited to the example embodiments, and various changes that can be understood by a person skilled in the art may be applied to the configuration and detail of the invention of the present application within the scope of the invention.

This application is based upon and claims the benefit of priority from Japanese patent application No. 2019-063149, filed on Mar. 28, 2019, the disclosure of which is incorporated herein in its entirety by reference.

### REFERENCE SIGNS LIST

1 Radio wave condition measurement means
2 Radio wave state fluctuation-detection means
3 Unexpected radio wave state fluctuation-detection means
4 Detailed information storage means
5 Wireless communication abnormality information-presenting means
11 Communication device information
12 Device running schedule information
13 Arrangement change schedule information
14 Robot operation schedule information
15 Communication condition change prediction information
21 Radio wave state fluctuation information
31 Information verification means
32 Unexpected radio wave state fluctuation-determination means
33 Detailed information collection means
34 Detailed information output means
100 Wireless communication monitoring system

What is claimed is:

1. A wireless communication monitoring system for monitoring a radio wave state in wireless communication; comprising:
a processor configured to:
hold, as prediction information, information related to a fluctuation in the radio wave state that is able to be predicted and a fluctuation in the radio wave state being permitted;
detect an occurrence of a fluctuation in the radio wave state, and set the occurrence as fluctuation information; and
output detailed information related to a fluctuation in the radio wave state when the fluctuation information detected does not coincide with the prediction information held.

2. The wireless communication monitoring system according to claim 1, the processor is further configured to compare the fluctuation information detected with the prediction information held.

3. The wireless communication monitoring system according to claim 1, wherein the prediction information includes at least one of attribute information related to a communication device, information indicating a running schedule of the communication device, information indicating an arrangement change schedule of the communication device, information indicating an operation schedule of a robot that emits a wireless radio wave in a wireless communication frequency band, information indicating a running schedule of a device other than the communication device, information indicating an arrangement change schedule of an obstacle, and information indicating an operation schedule of a robot that does not emit the wireless radio wave.

4. The wireless communication monitoring system according to claim 1, wherein the detailed information related to a fluctuation in the radio wave state includes information related to a position where a fluctuation in a radio wave state in wireless communication occurs and a frequency having a possibility of the fluctuation.

5. A wireless communication abnormality information presenting method for presenting detection of an occurrence of a fluctuation in a radio wave state in wireless communication, comprising:
holding, as prediction information, information related to a fluctuation in the radio wave state that is able to be predicted and a fluctuation in the radio wave state being permitted;
detecting an occurrence of a fluctuation in the radio wave state, and setting the occurrence as fluctuation information; and
outputting detailed information related to a fluctuation in the radio wave state when the fluctuation information detected in the detecting does not coincide with the prediction information held in the holding.

6. The wireless communication abnormality information presenting method according to claim 5, further comprising comparing the fluctuation information detected in the detecting with the prediction information held in the holding.

7. The wireless communication abnormality information presenting method according to claim 5, wherein the prediction information includes at least one of attribute information related to a communication device, information indicating a running schedule of the communication device, information indicating an arrangement change schedule of the communication device, information indicating an operation schedule of a robot that emits a wireless radio wave in a wireless communication frequency band, information indicating a running schedule of a device other than the communication device, information indicating an arrangement change schedule of an obstacle, and information indicating an operation schedule of a robot that does not emit the wireless radio wave.

8. The wireless communication abnormality information presenting method according to claim 5, wherein the detailed information related to a fluctuation in the radio wave state includes information related to a position where a fluctuation in a radio wave state in wireless communication occurs and a frequency having a possibility of the fluctuation.

9. A non-transitory computer-readable medium that stores a wireless communication abnormality information presenting program for processing of presenting detection of an occurrence of a fluctuation in a radio wave state in wireless communication, the wireless communication abnormality information presenting program causing a computer to execute:
holding, as prediction information, information related to a fluctuation in the radio wave state that is able to be predicted and a fluctuation in the radio wave state being permitted;
detecting an occurrence of a fluctuation in the radio wave state, and setting the occurrence as fluctuation information; and
outputting detailed information related to a fluctuation in the radio wave state when the fluctuation information detected in the detecting does not coincide with the prediction information held in the holding.

10. The non-transitory computer-readable medium according to claim 9, wherein the wireless communication abnormality information presenting program further includes a program causing the computer to execute comparing the fluctuation information detected in the detecting with the prediction information held in the holding.

11. The non-transitory computer-readable medium according to claim 9, wherein the prediction information includes at least one of attribute information related to a communication device, information indicating a running schedule of the communication device, information indicating an arrangement change schedule of the communication device, information indicating an operation schedule of a robot that emits a wireless radio wave in a wireless communication frequency band, information indicating a running schedule of a device other than the communication device, information indicating an arrangement change schedule of an obstacle, and information indicating an operation schedule of a robot that does not emit the wireless radio wave.

12. The non-transitory computer-readable medium according to claim 9, wherein the detailed information related to a fluctuation in the radio wave state includes information related to a position where a fluctuation in a radio wave state in wireless communication occurs and a frequency having a possibility of the fluctuation.
